(19) United States
(12) Patent Application Publication
(10) Pub. No.: US 2005/0115374 A1
(43) Pub. Date: Jun. 2, 2005

(54) Saw swaging and shaping apparatus

(76) Inventors: James Weatherly, Portland, OR (US); Larry McMaster, Boring, OR (US)

Correspondence Address: GLENN C. BROWN, PC, 777 NW WALL STREET, SUITE 308, BEND, OR, 97701, US

(21) Appl. No.: 10/804,782

(22) Filed: Mar. 19, 2004

Related U.S. Application Data
(60) Provisional application No. 60/456,139, filed on Mar. 19, 2003.

(51) Int. Cl. B26D 7/08

(52) U.S. Cl. 83/174

(57) ABSTRACT

A band saw blade swaging and shaping apparatus that automatically positions, swages and shapes saw teeth, and that generates a control signal responsive to detecting a predetermined position of the swaging or shaping apparatus.

### CROSS-REFERENCE TO RELATED APPLICATION

This application is a continuation-in-part of U.S. provisional patent application Ser. No. 60/456,139, filed on Mar. 19, 2003. The priority of the prior application is expressly claimed and its disclosure is hereby incorporated by reference in its entirety.

### BACKGROUND OF THE INVENTION

This invention relates to band saws, and in particular to equipment used to shape and sharpen the saw teeth. Commercial sawmills utilize large bands saws for log breakdown, i.e. rough sawing the log into boards. These band saws include blades that range from 7 to 16 inches in width, and 30-60 feet in length. The efficient operation of a band saw depends on the proper shaping of the teeth on the blade.

The cutting teeth of the band saw blades are swaged and shaped to optimize the cutting characteristics of the blade. Swaged refers to the aspect of the saw tooth shape wherein the cutting edge of each tooth is wider than the base of the tooth and saw plate. A properly swaged tooth provides clearance between the log and the body of the saw during cutting. The clearance reduces friction between the blade and the wood, which reduces heat buildup in the blade. The reduced friction and reduced heat build up in the blade extends blade life between sharpening operations and at the same time permits faster cutting rates. In addition, a properly swaged and shaped saw tooth permits the use of a thinner saw blade, reducing waste during the milling of the log. After the blade is swaged, it is then shaped to reach the final desired tooth configuration. Shaping of the blade refers to the side profile of the tooth shape behind and beneath the swaged cutting edge of the tooth.

The shaping of a band saw has much to do with the saw cutting straight and smooth. Each tooth must stand straight and have a perfect clearance at the point, with sharp, keen cutting corners. As mentioned, the point or cutting edge of a tooth should be the widest. The blade is then tapered along the “hook line”, i.e. the bottom edge of the tooth, to provide a desired the radial angle of the tooth when viewed from the side. The tooth is also tapered from the rear toward the point creating the proper profile of the side walls of the blade for optimal clearance. This also reduces friction during the cut, which reduces heat build up in the saw and affect its tension. Properly shaped, very thin saws can be run very efficiently, cutting a minimum kerf at a maximum cutting rate and output.

FIG. 1 below shows a tooth without swaging, FIG. 2 a tooth that has been swaged but not shaped and FIG. 3 a tooth that has been shaped, tapering the tooth downward and backward from point to afford a perfect clearance.

FIGS. 1-3 illustrate a type of swaging which is satisfactory for use on saws used for cutting hardwood or kiln-dried pine. When cutting softer woods that have a stringy or fibrous nature, such as many of those encountered on the Pacific Coast, it is preferable for the swage to extend farther down the face of the tooth, as shown in FIGS. 4 and 5.

Known methods and machines for shaping and swaging saw blades utilize separate shapers and swagers that are alternately mounted on the tooth being reshaped, and require numerous rounds of removing and reinstalling the shaper and swager to achieve the final desired tooth shape.

While the prior art methods and machines achieve the desired result, they are not particularly efficient. This invention provides an apparatus for shaping and swaging a saw blade without the need for removing and reinstalling the shaper and swager.

### BRIEF DESCRIPTION OF THE DRAWINGS

FIGS. 1-3 illustrate a type of swaging which is satisfactory for use on saws used for cutting hardwood or kiln-dried pine.

FIGS. 4-5 illustrate a type of swaging which is satisfactory for use on softer woods that have a stringy or fibrous nature, such as many of those encountered on the Pacific Coast.

FIG. 6 is a front elevational schematic view of the invention.

FIG. 7 is a top schematic view of the invention.

FIG. 8 is a front perspective view of an alternate embodiment of the swage assembly.

FIG. 9 is a front perspective view of an alternate embodiment of the swage assembly.

FIG. 10A is a perspective view of the swage head for the swage assembly shown in FIGS. 8 and 9.

FIG. 10B is an exploded perspective view of the same.

FIGS. 11A-11C are exploded, front and rear perspective views of the swage head.

FIGS. 12A-12D illustrate the swage-head mount.

FIGS. 13A and 13B are perspective and exploded perspective views of the swage clamp mounting block.

FIGS. 14A and 14B illustrate the subframe swage assembly carriage.

FIGS. 15A 15C illustrate the swage pivot frame

FIGS. 16A-16B illustrate the shaper head assembly.

FIG. 17A-17C are detail views of the shaper assembly shown in FIG. 16.

FIG. 18 is a perspective view of the fully assembled shaper assembly as mounted on the frame.

FIGS. 19A-19F illustrate details of the assembly shown in FIG. 18.

FIGS. 20A-20F illustrate the shaper in greater detail.

FIGS. 21A-21D illustrate the saw carriage plate.

FIG. 22 is a perspective view of the lower frame assembly on which the swage assembly, the shaper assembly and the control unit are mounted.

FIG. 23A-23B are perspective and side elevational views of the index assembly that advances the saw to position successive saw teeth in position for swaging and shaping.

FIGS. 24A-24B are elevational views of the control unit that receives positional signals from the swage assembly and activates the swaging assembly, shaper assembly and index assembly to advance the saw blade.

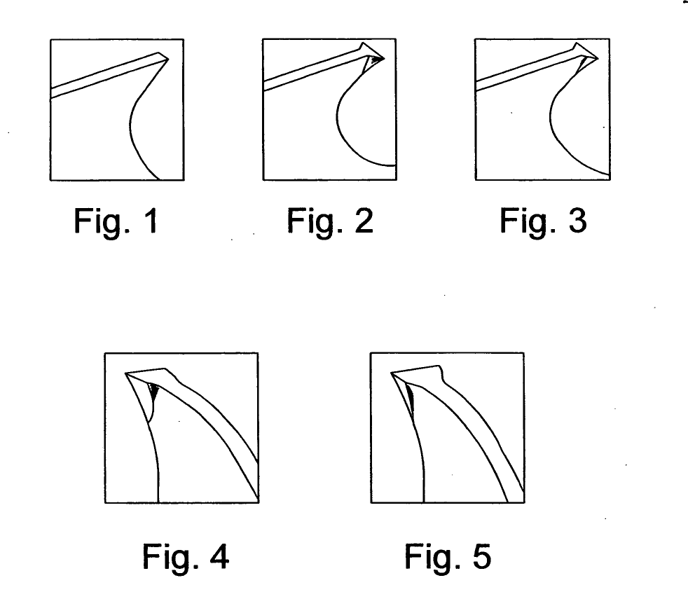

### DETAILED DESCRIPTION OF THE PREFERRED EMBODIMENTS

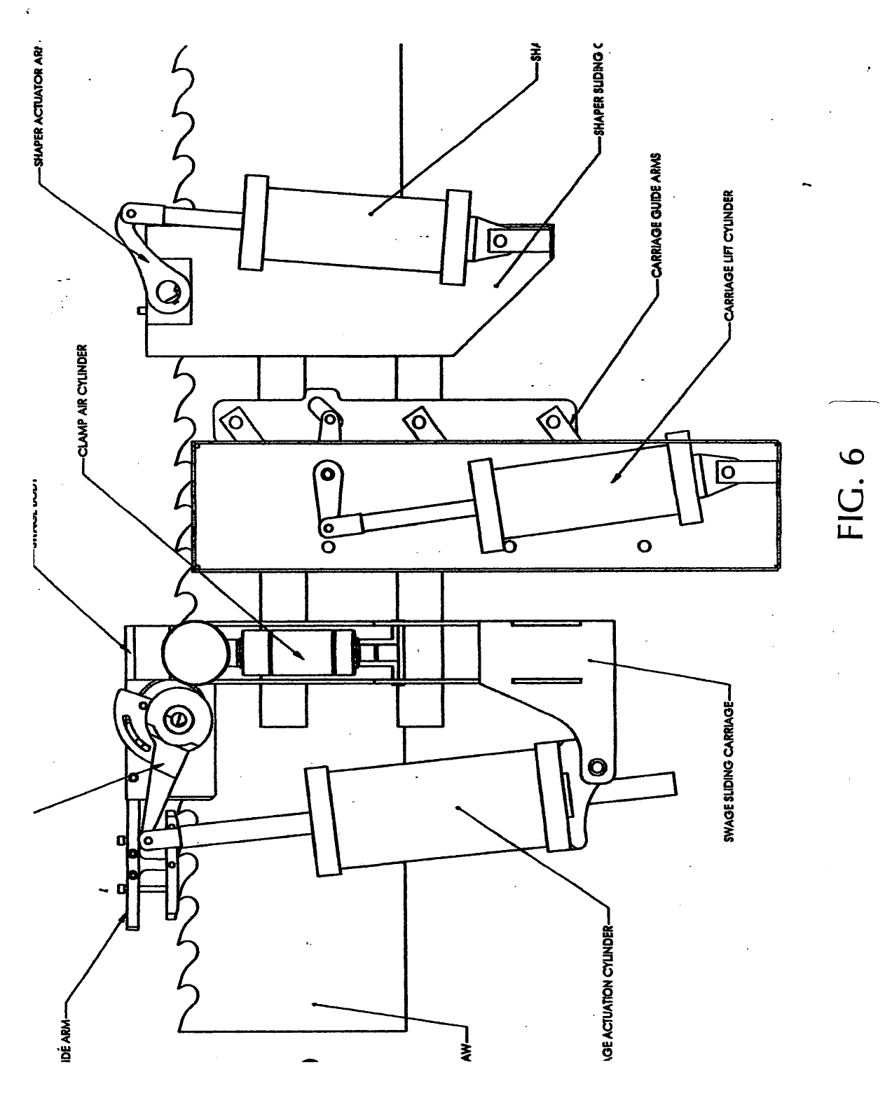

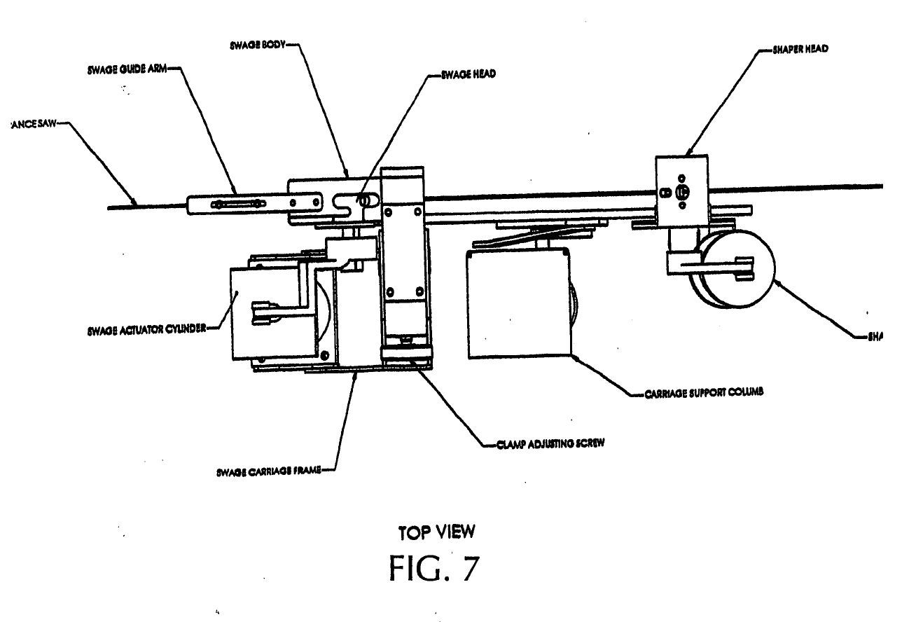

FIGS. 6 and 7 show a preferred embodiment of the preferred invention at 10. In general, the invention combines the operations of swaging and shaping the teeth of the saw, and responsive to control signals generated by position sensors on the swaging assembly, advances the saw blade incrementally to position subsequent teeth in position for swaging and shaping steps. The apparatus includes three major components: the carriage lift mechanism 12 that raises the saw blade 14 into position for being swaged and shaped as described in greater detail below, and then lowers and advances saw blade 14 to sequentially place the remaining saw blade teeth into position in the shaper and swaging dies. After the shaper and swager have been operated on their respective teeth, the saw is lowered and advanced to position the next set of teeth under the shaper and swager dies, and the process is repeated. In this way, the entire band saw is passed through the shaper and swager dies in a single pass. If further shaping and swaging is required, as is often the case since only a certain amount of material can be reshaped without damaging the blade, the dies are reset and the blade is passed through the apparatus again.

The second major component is the swage assembly 16, which includes an actuator cylinder 18, an anvil angle setting plate 20, a swage body 22, a rotatable swage die 23 and operating arm 24, a swage guide arm 26, a swage guide shoe 28. Swage assembly 16 operates to swage the blades by providing an internal surface on swage body 22 that rests against the upper surface of the saw tooth. The swage actuating cylinder 18 is then extended, moving operating arm 24 and rotating swage die 23 into engagement with the lower surface of the saw tooth, and swaging the tip of the saw tooth. Rotating swage die 23 is mounted eccentrically so that as it is rotated a peripheral surface engages the lower surface of the saw blade to deform the blade tip into the desired amount.

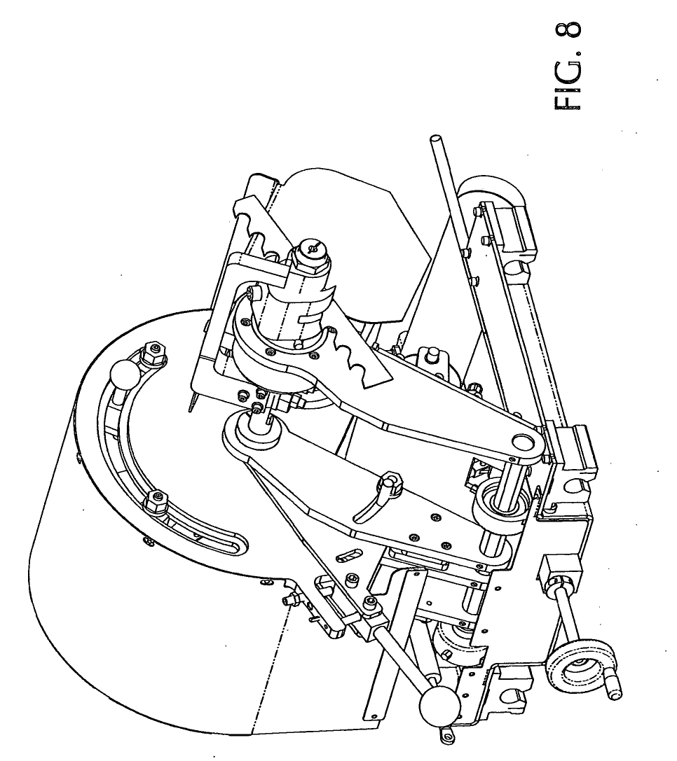

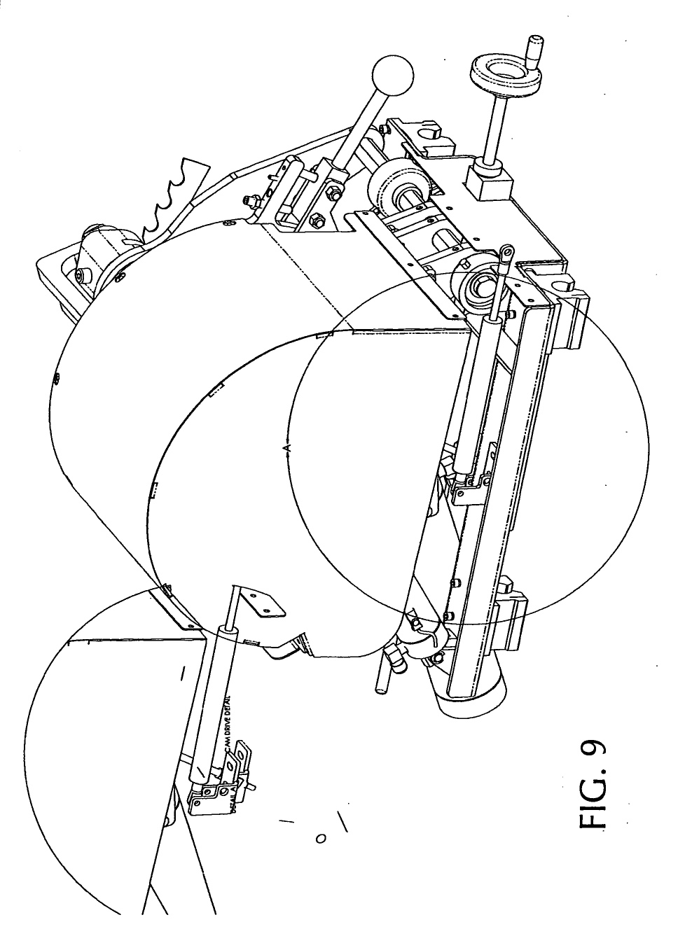

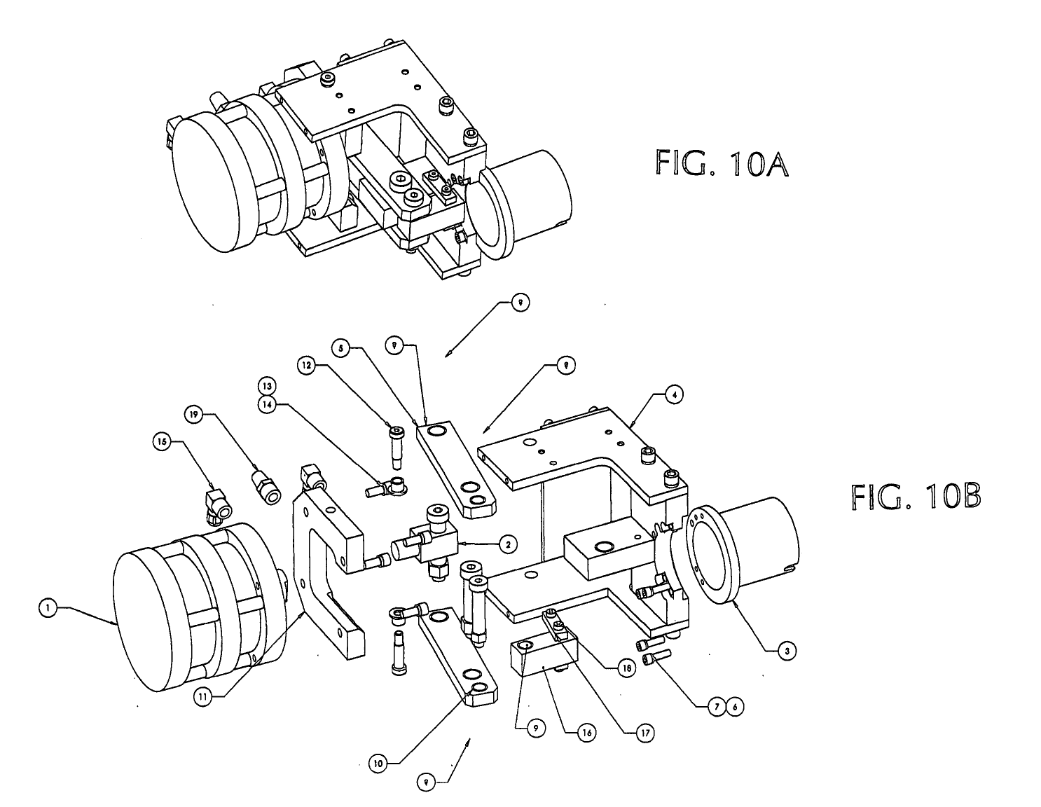

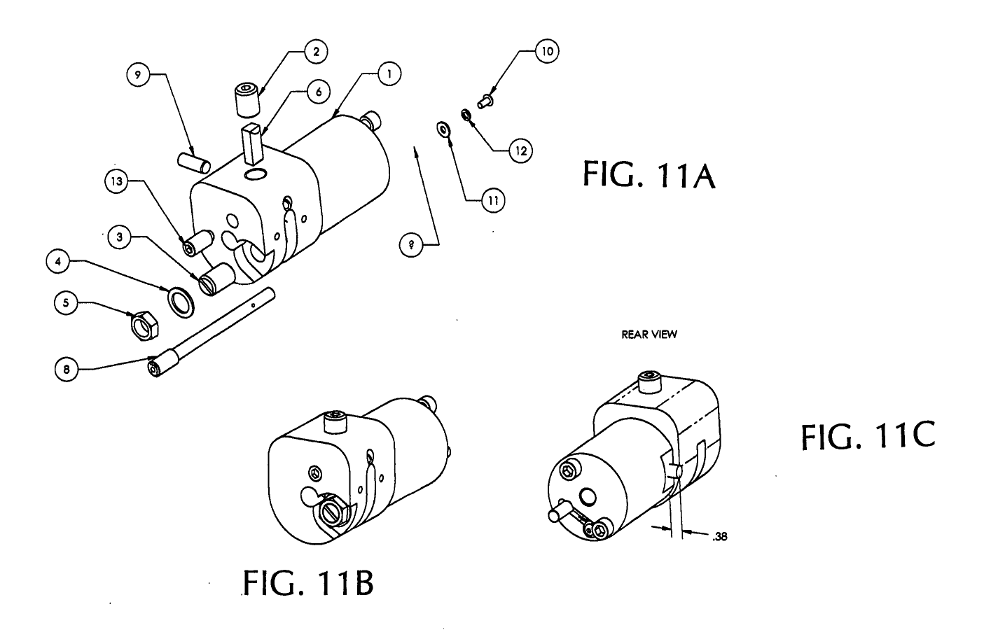

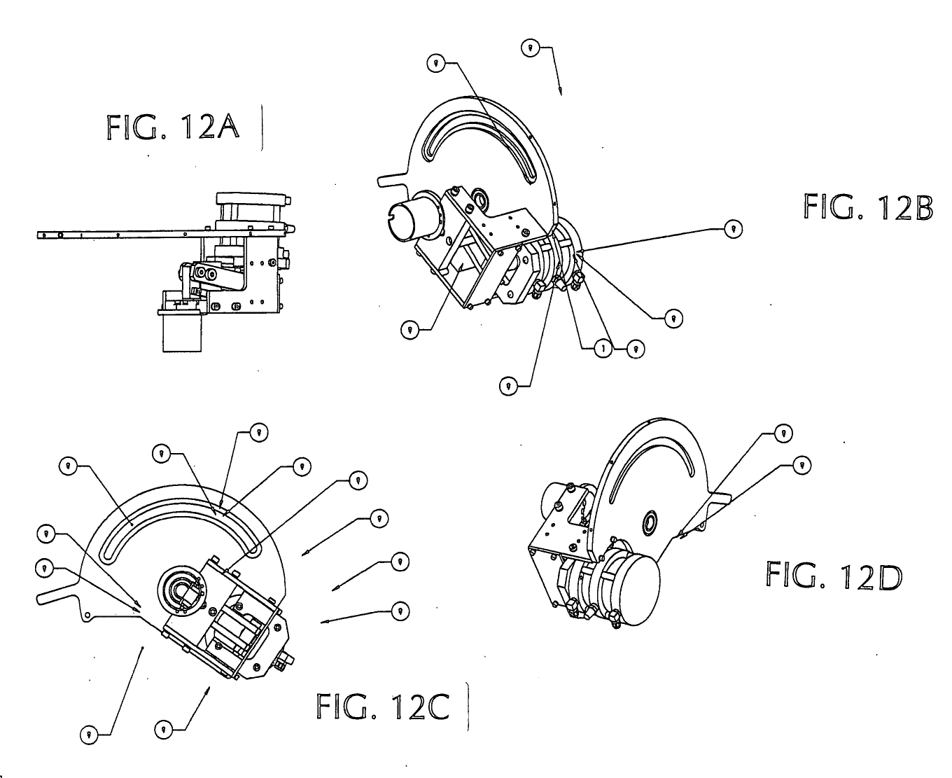

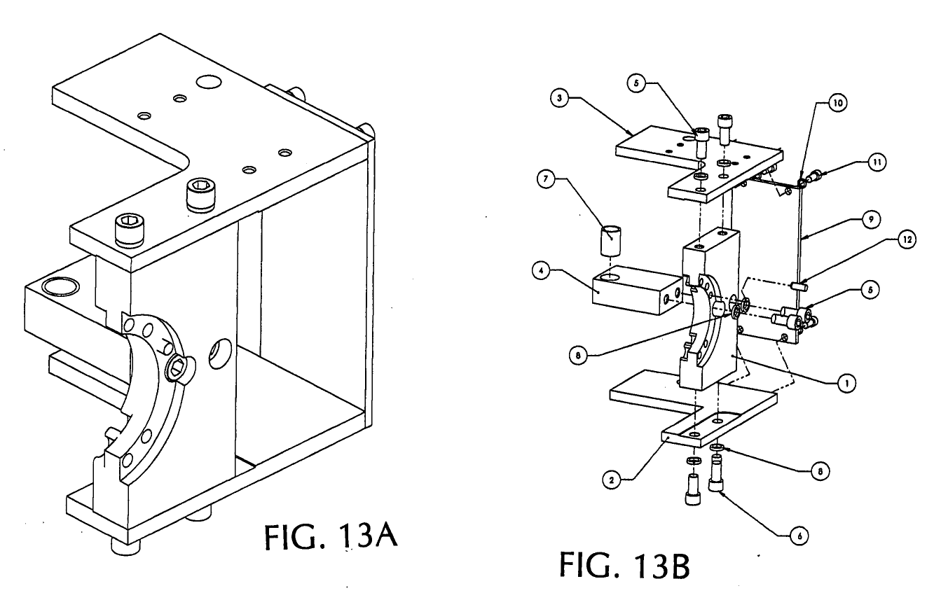

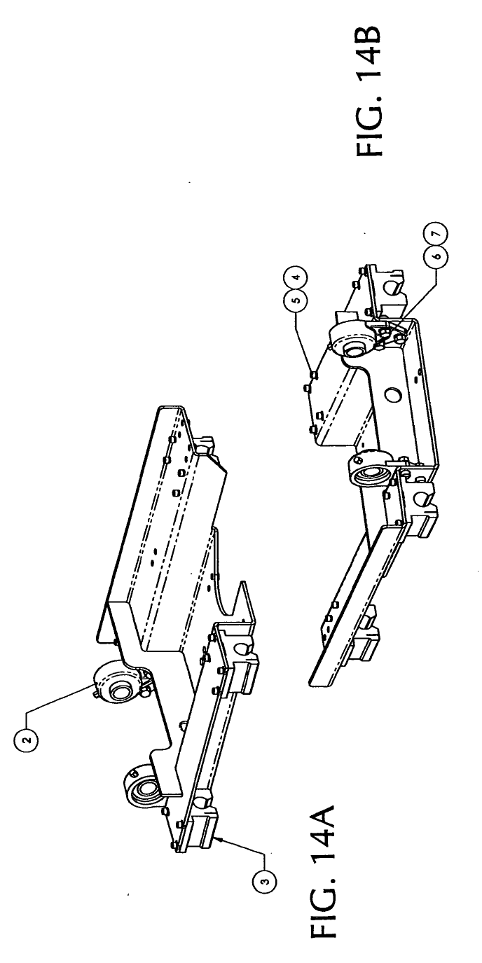

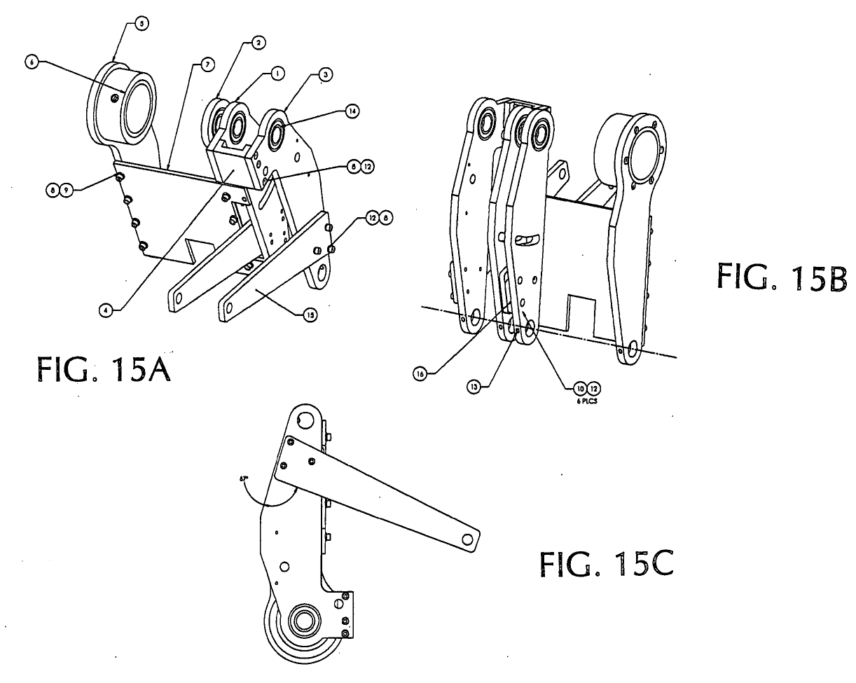

An alternative embodiment of the swaging assembly is shown in FIGS. 8-15. FIGS. 8 and 9 are front and rear perspective views of an alternate embodiment of the swage assembly 831, which is mounted on lower frame 2201 (FIG. 22). FIG. 10 A is a perspective view of the swage mounting head for the swage assembly shown in FIGS. 8 and 9. FIG. 10B is an exploded perspective view of the same. FIGS. 11A-11C are exploded, front and rear perspective views of the swage head. FIGS. 12A-12D illustrate the swage-head mount. FIGS. 13A and 13B are perspective and exploded perspective views of the swage clamp mounting block, which is mounted on the subframe swage assembly carriage, which is shown in FIGS. 14A and 14B. FIGS. 15A 15C illustrate the swage pivot frame.

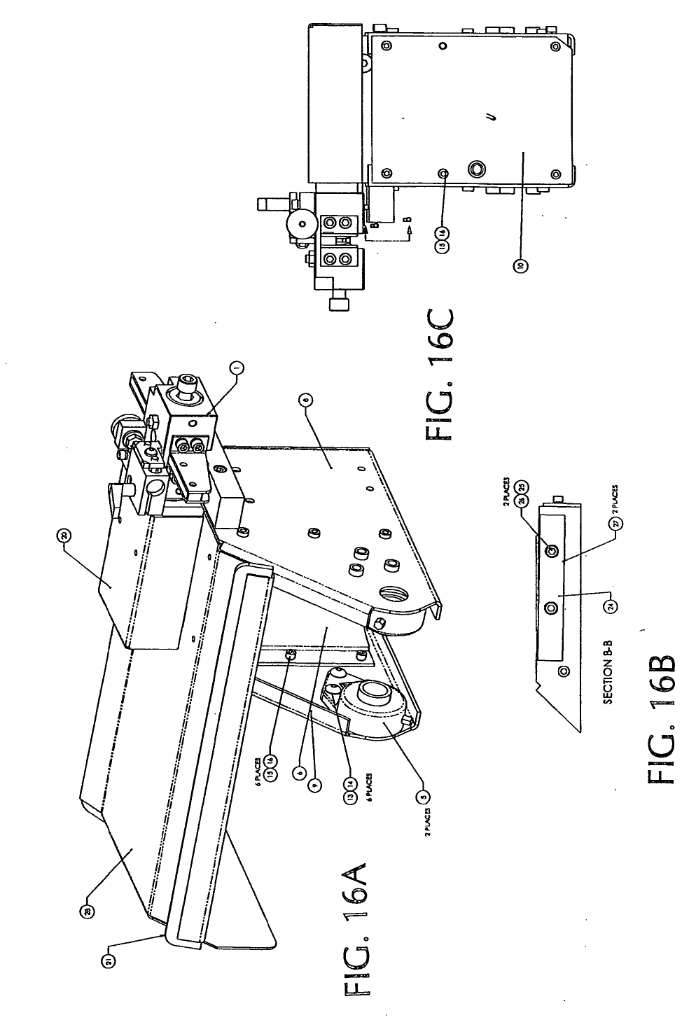

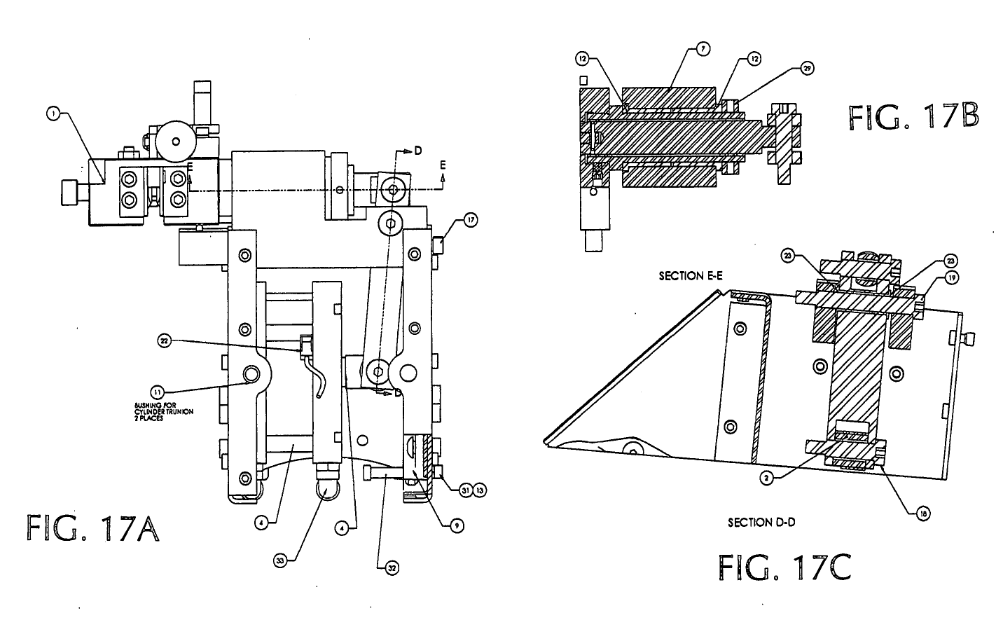

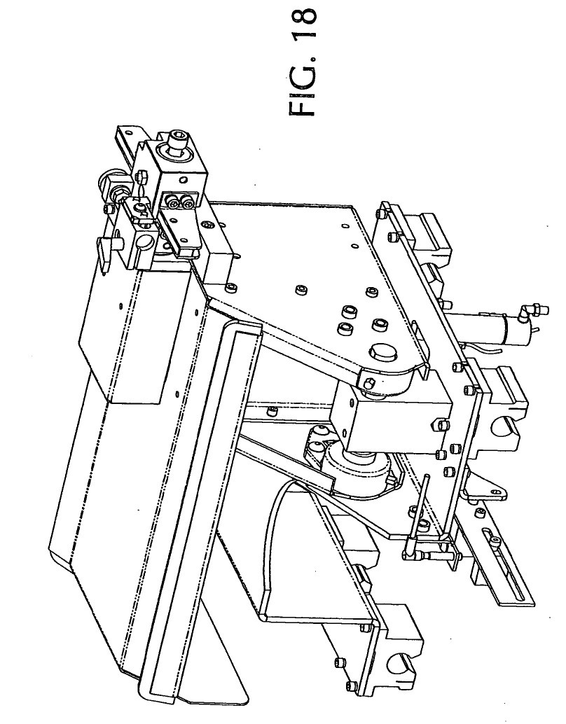

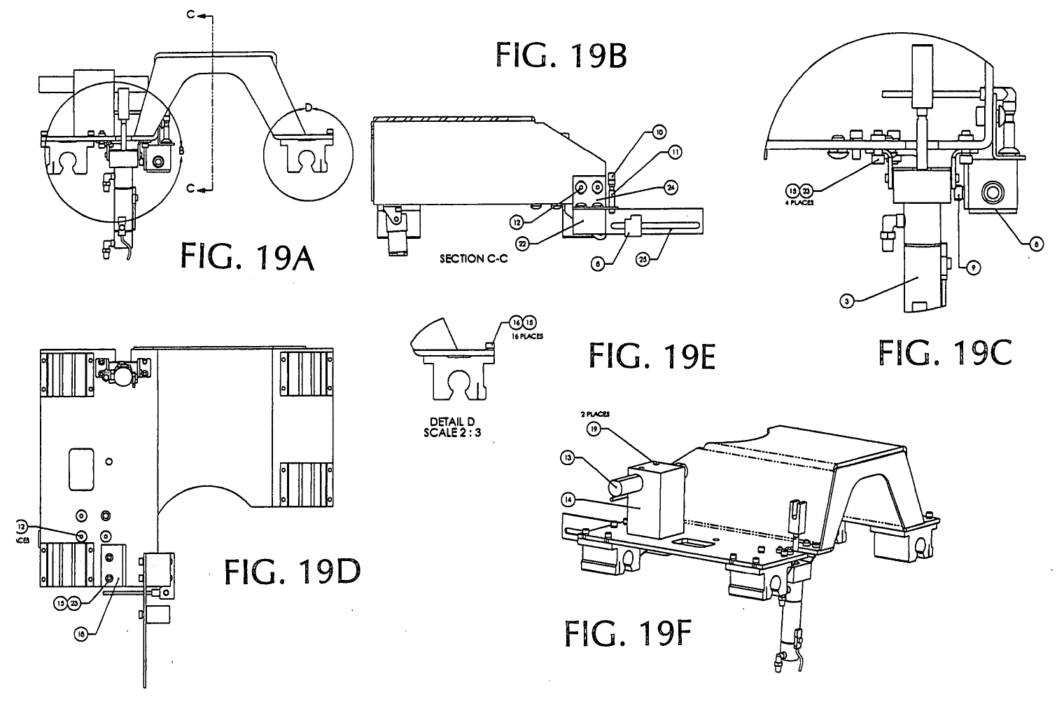

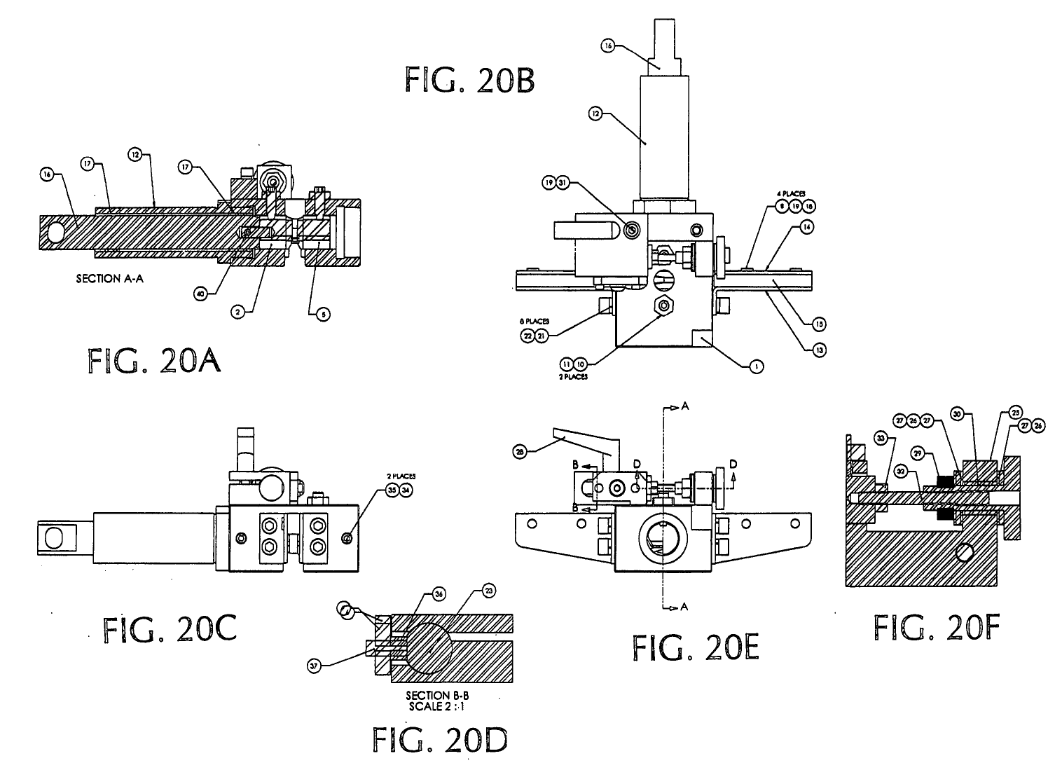

The third major assembly is the shaping apparatus 30, as shown in FIG. 7, and if FIGS. 16A-20F. Shaping apparatus 30 includes actuator cylinder 32, shaper head 34, and shaper actuator arm 36. Shaper actuator arm 36 is mounted on shaper actuator shaft 38. Shaper actuator shaft 38 is mounted in shaper head 34 and when rotated, rotates a cam-like surface against each of the shaping dies. The cam surfaces urge the opposed shaping dies against the saw tooth's opposite side faces and “forges” the tooth into the desired profile. A preferred embodiment of the shaper assembly is shown in various elevational and detail views in FIGS. 16A-20F. FIG. 18 shows a perspective view of the complete shaper assembly, including shaper head (FIGS. 16A-16C), which is rotatably mounted on the shaper carriage (FIGS. 19A-F). Shaper head 34 is shown in detail in FIGS. 20A-F.

The set up of the swaging die and the shaping dies to achieve any desired saw tooth shape and profile is done according to standard industry practice, as one of ordinary skill in the art would readily understand.

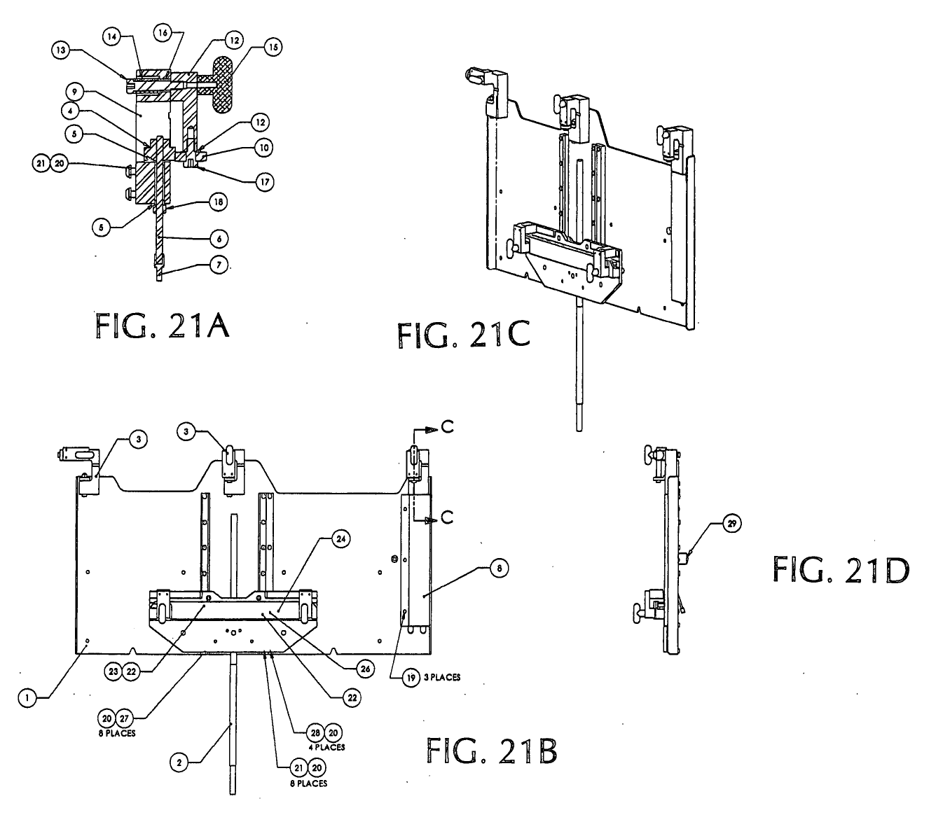

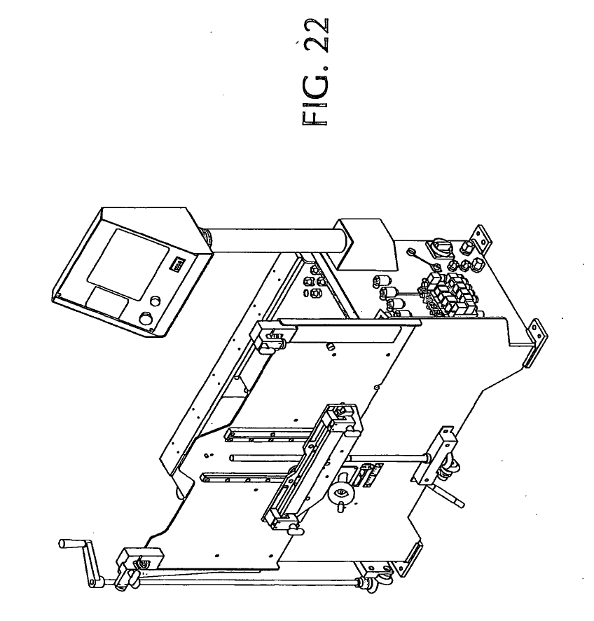

Turning to FIGS. 21A-D, the saw carriage plate is illustrated. The saw carriage plate is mounted on the lower frame assembly (FIG. 22), and is vertically adjustable to support the saw blade in the proper vertical location for positioning the saw teeth in the shaping and swaging anvils.

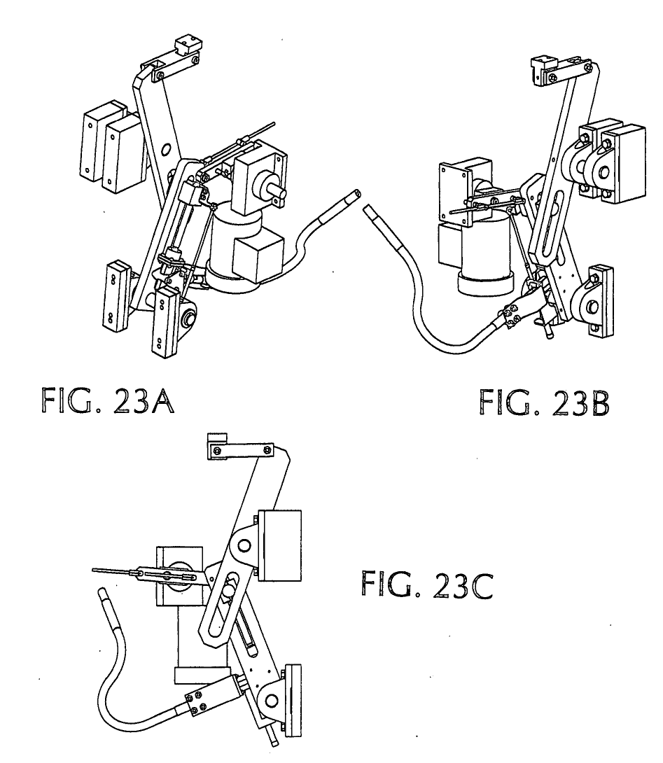

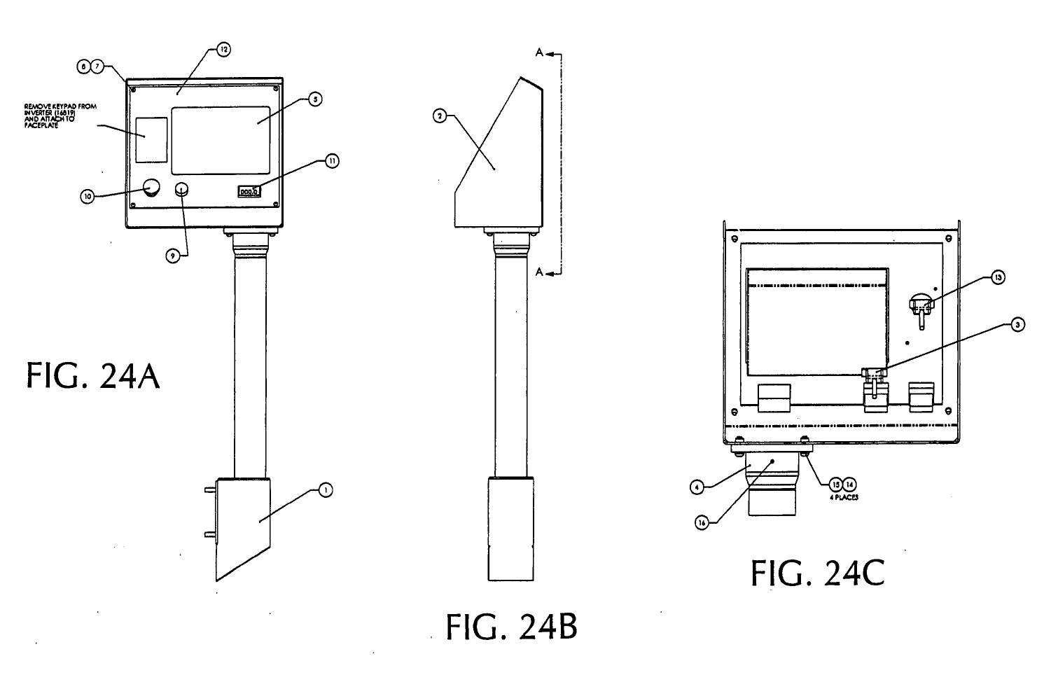

The saw carriage plate, the swaging assembly, the shaping assembly, and the controller are mounted on a lower frame assembly that is illustrated in FIG. 22. The swaging assembly and the shaper are pneumatically activated by by the controller responsive to control signals generated by limit switches. In one preferred embodiment, limit switches on the swaging assembly detect the end of the swaging stroke in the swaging assembly. The controller then generates a control sequence which pneumatically raises the swaging and shaping assemblies, advances the saw blade by one tooth, and then lowers the swaging and shaper heads into position to operate on the next saw tooth. The controller then activates each of the swaging and shaping assemblies to perform their respective shaping operations on the saw tooth positioned in each of the respective assemblies. The indexing assembly that advances the saw blade is shown in FIGS. 23A-C.

Those of skill in the art will recognize that numerous modifications in detail and arrangement are possible without departing from the scope of the following claims, and that the foregoing description of the preferred embodiments are intended as illustrative and not intended to limit the scope of the claims.

1. An apparatus for swaging and shaping a saw blade comprising:
a swaging assembly in communication with the blade positioning and transport mechanism and including an anvil surface adapted for engaging a top surface of a saw tooth, opposed members for clamping the saw tooth, an eccentric rotatable swaging die for swaging the saw tooth, and a sensor for detecting a predetermined rotational position of the swaging die;
a shaping assembly including opposed operable shaping dies having blade shaping surfaces and operable to engage and form opposed side surfaces of a saw tooth into predetermined shapes;
a blade positioning mechanism in communication with the swaging assembly and with the shaping assembly, and operable to sequentially position in a first position in the swaging assembly with the saw tooth top surface adjacent the anvil surface, and to then reposition the saw tooth to a second position in the shaping assembly between the shaping dies; and,
a control mechanism in communication with the swaging assembly and the shaping assembly and operable to position the saw tooth in the swaging assembly, to rotate the swaging die into contact with the saw tooth, to detect a predetermined rotational position of the swaging die, to move the saw tooth from the swaging assembly to the shaping assembly and operate the shaping dies.

2. An apparatus according to claim 1 further comprising the swaging assembly including an arm mounted on the swaging die, limit switches engageable with the arm and in communication with the control mechanism and operable to generate a control signal in response to engagement with the arm,

3. An apparatus according to claim 1 further comprising the swaging die including at least one position indicator indicating the rotational position of the swaging die, and a sensor in communication with the swaging die and the control mechanism and operable to generate a control signal responsive to detection of a predetermined portion of the machine readable position indicators.

5. An apparatus according to claim 5 wherein the machine readable position indicator is a machine readable visual position indicator.

6. An apparatus according to claim 5 wherein the machine readable position indicator is a magnetic position indicator.

7. An apparatus according to claim 6 wherein the magnetic position indicator comprises at least one groove formed in the swaging die and a magnetic material disposed within the at least one groove.

8. An apparatus according to claim 1 further comprising the swaging assembly including a clamping mechanism operable to fix the saw tooth in position in the swaging assembly.
